(19) United States
(12) Patent Application Publication
(10) Pub. No.: US 2023/0408772 A1
(43) Pub. Date: Dec. 21, 2023

(54) FURCATION TUBE VACUUM ASSIST

(71) Applicant: viaPhoton, Inc., Aurora, IL (US)

(72) Inventor: Morgan Dunn, Dallas, TX (US)

(73) Assignee: viaPhoton, Inc., Aurora, IL (US)

(21) Appl. No.: 18/205,332

(22) Filed: Jun. 2, 2023

Related U.S. Application Data
(60) Provisional application No. 63/348,835, filed on Jun. 3, 2022.

(51) Int. Cl. G02B 6/36; G02B 6/54; G02B 6/44

(52) U.S. Cl. CPC G02B 6/362; G02B 6/54; G02B 6/4431

(57) ABSTRACT

Systems and methods implement furcation tube vacuum assist. A furcation tube is annealed. The furcation tube is inserted into an adapter fitted to a vacuum line. A vacuum is applied to the furcation tube. One or more communication cables are moved through the furcation tube while the vacuum is applied.

### CROSS-REFERENCE TO RELATED APPLICATIONS

This application claims the benefit of US Provisional Patent Application No. 63/348,835, filed on Jun. 3, 2022, the entire disclosure of which is incorporated herein by reference.

### BACKGROUND

Furcation tubes, also referred to as furcation sleeves or furcation kits, are used to protect and manage the point where individual cables branch out from a main cable or bundle. A challenge is to insert cables into the furcation tubes.

### SUMMARY

In general, in one or more aspects, the disclosure relates to a method implementing furcation tube vacuum assist. A furcation tube is annealed. The furcation tube is inserted into an adapter fitted to a vacuum line. A vacuum is applied to the furcation tube. One or more communication cables are moved through the furcation tube while the vacuum is applied.

In general, in one or more aspects, the disclosure relates to a system implementing furcation tube vacuum assist. The system includes an adapter. The adapter structured to receive a furcation tube that is annealed and to fit to a vacuum line. A vacuum is applied to the furcation tube from the vacuum line. One or more communication cables are received through the furcation tube while the vacuum is applied.

In general, in one or more aspects, the disclosure relates to a system implementing furcation tube vacuum assist. The system includes an adapter with a conical receptacle. The adapter structured to receive a furcation tube that is annealed and to fit to a vacuum line. A vacuum is applied to the furcation tube from the vacuum line. One or more communication cables are received through the furcation tube while the vacuum is applied.

Other aspects of the invention will be apparent from the following description and the appended claims.

### BRIEF DESCRIPTION OF DRAWINGS

FIG. 1A and FIG. 1B show examples of systems in accordance with the disclosure.

FIG. 2A and FIG. 2B show examples of methods in accordance with the disclosure.

FIG. 3A, FIG. 3B, FIG. 3C, and FIG. 3D show examples of embodiments in accordance with the disclosure.

### DETAILED DESCRIPTION

In general, embodiments are directed to using a vacuum to assist assembly with furcation tubes. In the production of communication cable assemblies, including those with fiber optic cables, one or more individual fibers may be inserted and fed through a furcation tube. A furcation tube includes an outer jacket, which may be about 2 to 3 millimeter (mm) outer diameter, reinforcing aramid fiber, and a concentric inner tube, typically 0.6 to 1.6 mm inner diameter. The fiber is fed through the inner tube. In one embodiment, the fibers are inserted into the inner tube of the furcation tube, and then manually fed through the furcation tube, pushing the fiber in one small segment at a time. Each segment may be about 2 to 3 centimeters. The tedious and time-consuming process of feeding the communication cable (e.g., an optical fiber) through the furcation tube is improved by using vacuum assist.

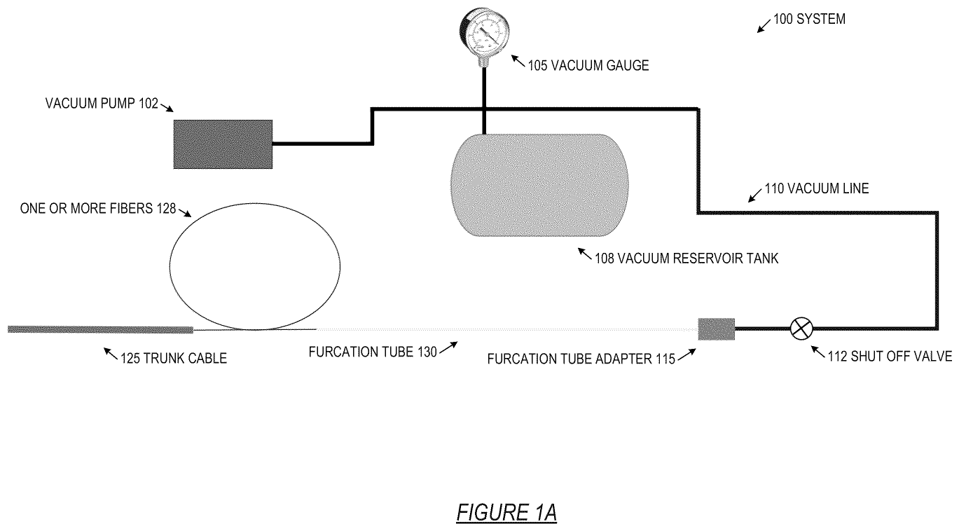

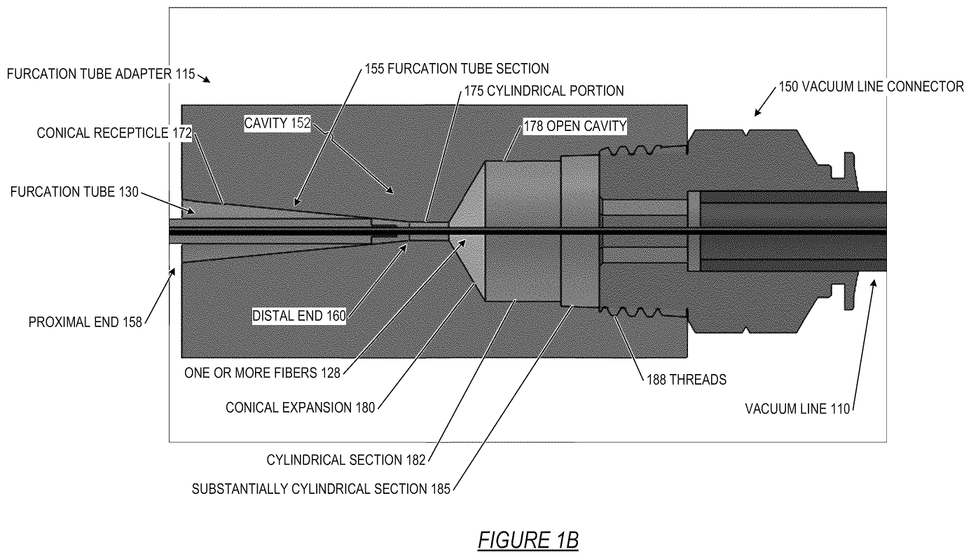

Turning to FIG. 1A, the system (100) implements furcation tube vacuum assist. The system (100) assists the insertion of the one or more fibers (128), from the trunk cable (125) to the furcation tube (130). The system (100) includes the vacuum pump (102), the vacuum gauge (105), the vacuum reservoir tank (108), the vacuum line (110), the shut off valve (112), and the furcation tube adapter (115).

The vacuum pump (102) provides the vacuum pressure for the system (100). The vacuum pump (102) is a mechanical device that removes gas molecules to create a vacuum or low-pressure environment within the system (100). The vacuum pump (102) creates a pressure differential with the surrounding environment by removing gas molecules from the system (100), thereby lowering the pressure inside. The vacuum pump (102) may be a positive displacement pump, a momentum transfer pump, a diffusion pump, etc.

The vacuum gauge (105) displays the vacuum pressure of the system (100). The vacuum gauge (105) is a measuring instrument used to quantify and display the level of vacuum or low pressure within the system (100). The vacuum gauge (105) provides a visual or numerical indication of the pressure, allowing the vacuum conditions to be monitored and controlled.

The vacuum reservoir tank (108) provides a reserve amount of vacuum pressure. The vacuum reservoir tank (108), which may also be referred to as a vacuum accumulator or vacuum buffer tank, is a storage device used to maintain a reserve of vacuum pressure. The vacuum reservoir tank (108) is structured to store and release vacuum on demand, providing a stable and consistent vacuum supply to the system (100). The vacuum reservoir tank (108) compensates for fluctuations or sudden changes in vacuum demand. In one embodiment, the vacuum pump (102) may not be able to supply an immediate surge of vacuum. The vacuum reservoir tank (108) acts as a buffer, storing excess vacuum pressure during low-demand periods and releasing it when there is a sudden increase in demand.

The vacuum line (110) connects between the vacuum pump (102), the vacuum gauge (105), the vacuum reservoir tank (108), the shutoff valve (112), and the furcation tube adapter (115). The vacuum line (110) is a network of tubing or pipes used to transport gases in a vacuum environment of the system (100). The vacuum line (110) serves as a conduit to connect different components and devices within the system, allowing the transfer of gases, samples, or other materials under vacuum conditions. The vacuum line (110) may be made of materials that withstand the low-pressure environment, including stainless steel, glass, plastics, etc.

The shut off valve (112) connects and disconnect the vacuum pressure from the vacuum line (110) to the furcation tube adapter (115). The shut off valve (112), which may also be referred to as an isolation valve or stop valve, is a mechanical device used to control or halt the flow of gas, and thereby the vacuum, through system (100). When the shut off valve (112) is open, the shut off valve (112) allows unobstructed flow through the system (100) to create a vacuum in the furcation tube (130). Conversely, when the valve is closed, it creates a seal that prevents the passage of fluid or gas so that the furcation tube (130) is a room pressure without a vacuum. The furcation tube adapter (115) connects between the furcation tube (130) and the vacuum line (110). The furcation tube adapter (115) facilitates efficient and reliable seal for the vacuum generated in the vacuum line (110) to transfer the furcation tube (130). In one embodiment, the furcation tube adapter (115) may be made of a rigid material, including metal, plastic, etc.

The trunk cable (125) is a high-capacity cable that contains the multiple individual communications cables. The communication cables are structured to transmit signals, data, or information between different devices or locations and serve as a physical medium for carrying electrical or optical signals. The communications cables of the trunk cable (125) may include the optical fibers (128) bundled together within one or multiple sheaths. The trunk cable (125) is used to establish connections between different points in a network, providing a reliable and efficient means of transmitting large volumes of data over long distances. When installed the trunk cable (125) may be deployed in outdoor or long-haul applications, such as telecommunications networks, data centers, or interconnectivity between buildings.

The one or more fibers (128) are thin, flexible strands made of high-quality glass or plastic materials to pass optical signals. The one or more fibers (128) are structured to transmit data as pulses of light.

The furcation tube (130) is a protective component used to manage and protect the individual communication cables, including the one or more fibers (128), in a cable assembly. The furcation tube (130) is structured to provide strain relief, support, and protection for the communication cables, ensuring integrity of the communication cables and minimizing the risk of damage or signal loss when installed and operated.

Turning to FIG. 1B, a cross section of the furcation tube adapter (115) is illustrated. The furcation tube adapter (115) includes the cavity (152) through which the one or more fibers (128) are pulled. The cavity (152) includes the furcation tube section (155) formed as the conical receptacle (172). The conical receptacle (172) is, juxtaposed to the cylindrical portion (175), which is juxtaposed to the open cavity (178).

The open cavity (178) includes a conical expansion (180), the cylindrical section (182), and the substantially cylindrical section (185). The conical expansion (180) is juxtaposed between the cylindrical portion (175) and the cylindrical section (182) with a radius that increases from the cylindrical portion (175) to the cylindrical section (182). The cylindrical section (182) is juxtaposed between the conical expansion (180) and the cylindrical section (182). The substantially cylindrical section (185) connects to the cylindrical section (182) and is slightly conical with a radius that increases by about 1 to 10 percent before meeting with the threads (188).

The furcation tube section (155) includes the proximal end (158) with a proximal diameter being greater than a furcation tube diameter. The furcation tube section (155) includes the distal end (160) with a distal diameter being less than the furcation tube diameter.

The furcation tube adapter (115) further includes the threads (188). The threads (188) secure the furcation tube adapter (115) to the vacuum line connector (150).

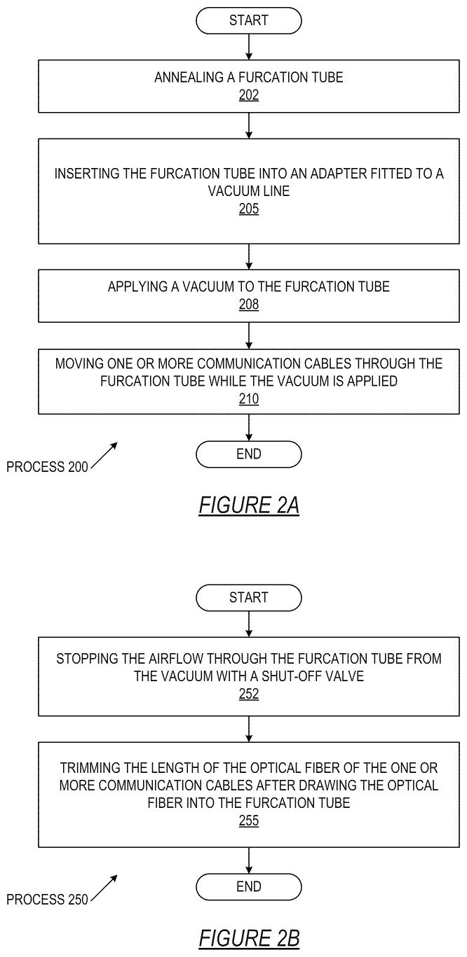

Turning to FIG. 2A, the process (200) implements furcation tube vacuum assist. The process (200) may be performed by a mechanical system controlled by a computing system executing instructions, stored in a memory, with a processor.

At Step 202, the furcation tube is annealed. In one embodiment, annealing of the furcation tube involves a process with three stages. The furcation tube is heated over a heating period to reach a specific temperature referred to as a hold temperature. The hold temperature is then maintained for a holding period. Subsequently, the tube is cooled down to room temperature over a cooling period. In one embodiment, during annealing, the hold temperature may exceed 500 degrees Celsius, and the heating period may last about ten minutes. Subsequently, the hold temperature may be sustained for about twenty minutes, which may ensure proper treatment. The furcation tube undergoes a cooling period of about twelve minutes until it reaches the ambient room temperature, which may be in the range of 20 to 25 degrees Celsius.

At Step 205, the furcation tube is inserted into an adapter fitted to a vacuum line. The furcation tube is inserted into an adapter that is structured to fit onto a vacuum line and maintain vacuum. The vacuum line is a semirigid tube. The adapter includes multiple components, including a conical receptacle, a cylindrical portion, and an open cavity. The conical receptacle has a proximal end with a larger diameter than the outer diameter of the furcation tube, and a distal end with a smaller diameter than the outer diameter of the furcation tube but larger than the diameter of the communication cables. The cross-sectional area of the distal end of the conical receptacle is less than the cross-sectional area from the circumference of the outer wall of the furcation tube. The cross-sectional area from an inner wall of the furcation tube is greater than the cross-sectional area of the one or more communication cables that pass through the furcation tube. The open cavity within the adapter includes a conical expansion, a cylindrical section, and a substantially cylindrical section.

At Step 208, a vacuum is applied to the furcation tube. To maintain the vacuum pressure, a vacuum reservoir tank with an appropriate volume is utilized. In one embodiment, the vacuum reservoir tank is used to maintain the vacuum at a level equal to or less than about 0.4 pounds per square inch absolute (PSIA), with a tolerance of approximately plus or minus 10 percent. The vacuum is generated with an airflow of around 7 cubic feet per minute (CFM), providing a suction force to the communication cables to be pulled through the furcation tube.

In one embodiment, the application of the vacuum is controlled on-demand using a foot-operated shut-off valve. When the vacuum is engaged, it applies a force of approximately 0.2 ounces to the optical fiber of the communication cables to be pulled through the furcation tube.

In one embodiment, the system is structured to maintain the vacuum for a defined period of time, such as 5 seconds, allowing sufficient time for the required operations to be carried out. The components of the system provide the desired vacuum pressure and airflow, along with the controlled application of force on the optical fibers, contributing to the movement of the communication cables through the furcation tube.

At Step 210, one or more communication cables are moved through the furcation tube while the vacuum is applied. In one embodiment, a cable of the one or more communication cables includes an optical fiber.

In one embodiment, the length of the optical fiber of the one or more communication cables is greater than a length of the furcation tube, which may be about two meters.

In one embodiment, the furcation tube includes an inner diameter forming a clearance between the inner diameter and diameters of the one or more communication cables. The clearance is greater than about 0.1 millimeter. The inner diameter of the furcation tube is about 0.6 millimeters. The one or more communication cables include two optical fibers each with a diameter of 0.25 millimeters.

Turning to FIG. 2B, the process (250) implements furcation tube vacuum assist with additional steps. The process (250) may be performed by a mechanical system controlled by a computing system executing instructions, stored in a memory, with a processor.

At Step 252, the airflow through the furcation tube from the vacuum is stopped with a shut-off valve. In one embodiment, the shut-off valve may be actuated automatically responsive to a sensor detecting the fibers being pulled through the furcation tube. For example, the sensor may measure the length of the fiber that has been pulled into the furcation tube and stop the airflow of the vacuum when a predetermined length has been measured, e.g., 2.1 meters.

At Step 255, the length of the optical fiber of the one or more communication cables is trimmed after drawing the optical fiber into the furcation tube. The furcation tube, communication cables, and optical fibers may be removed from the adapter and one or more of the optical fibers may be trimmed to reduce the length of the optical fiber extending past an end of the furcation tube.

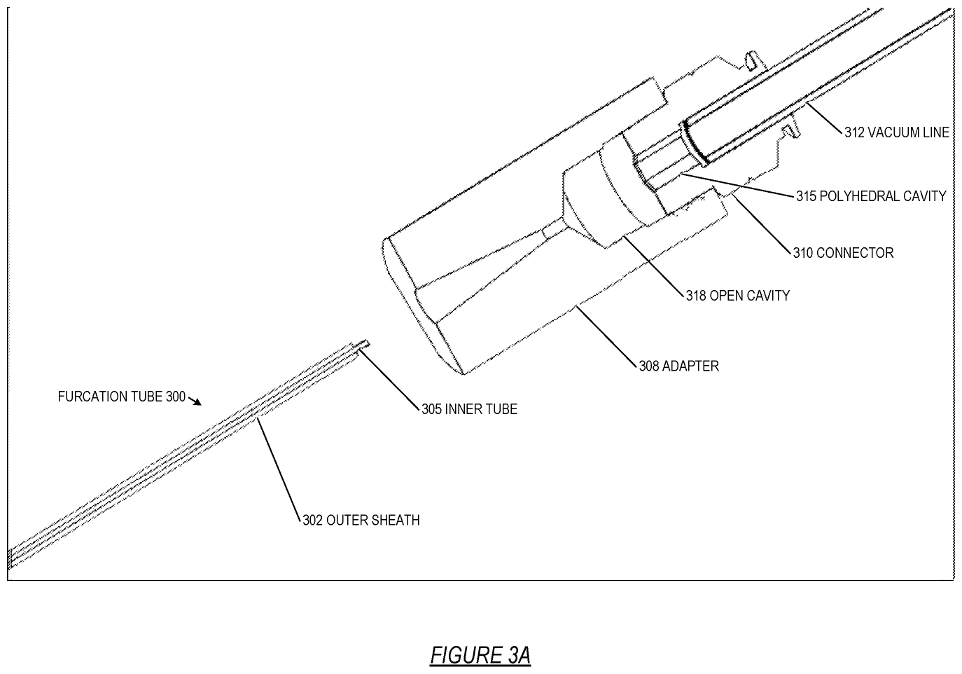

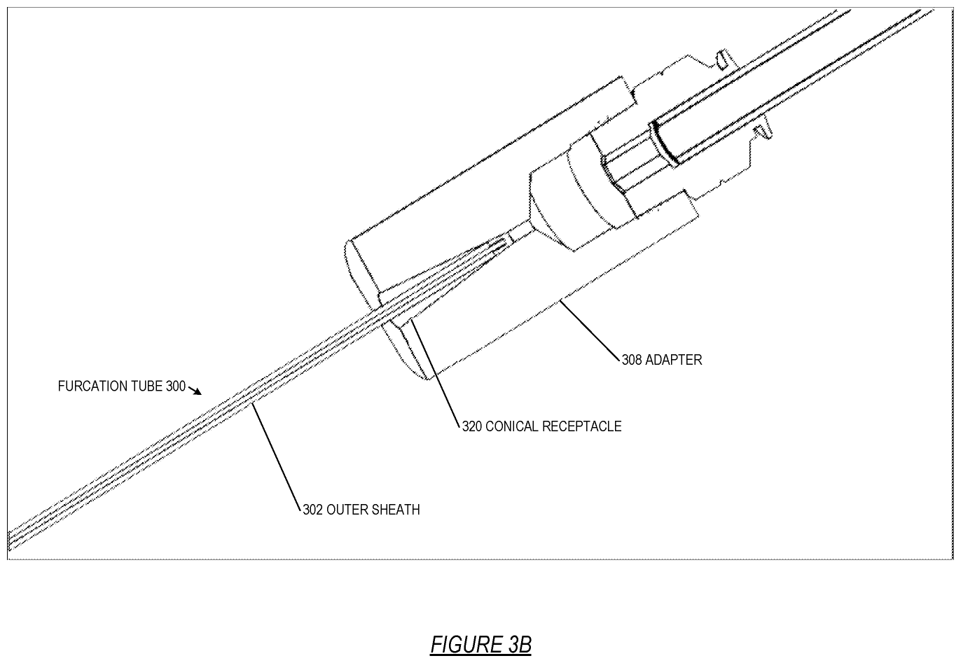

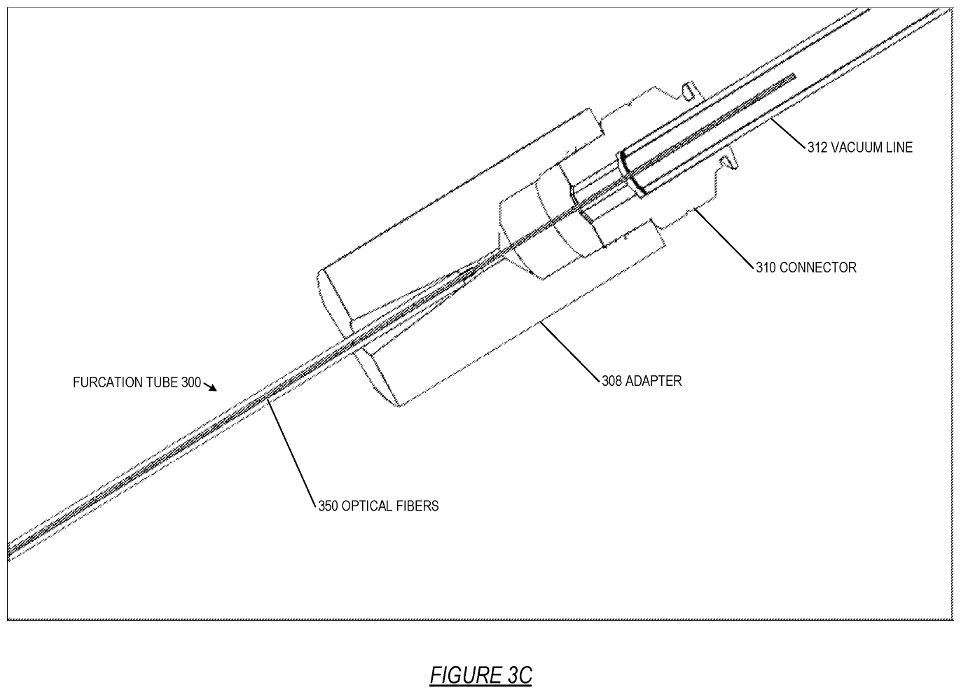

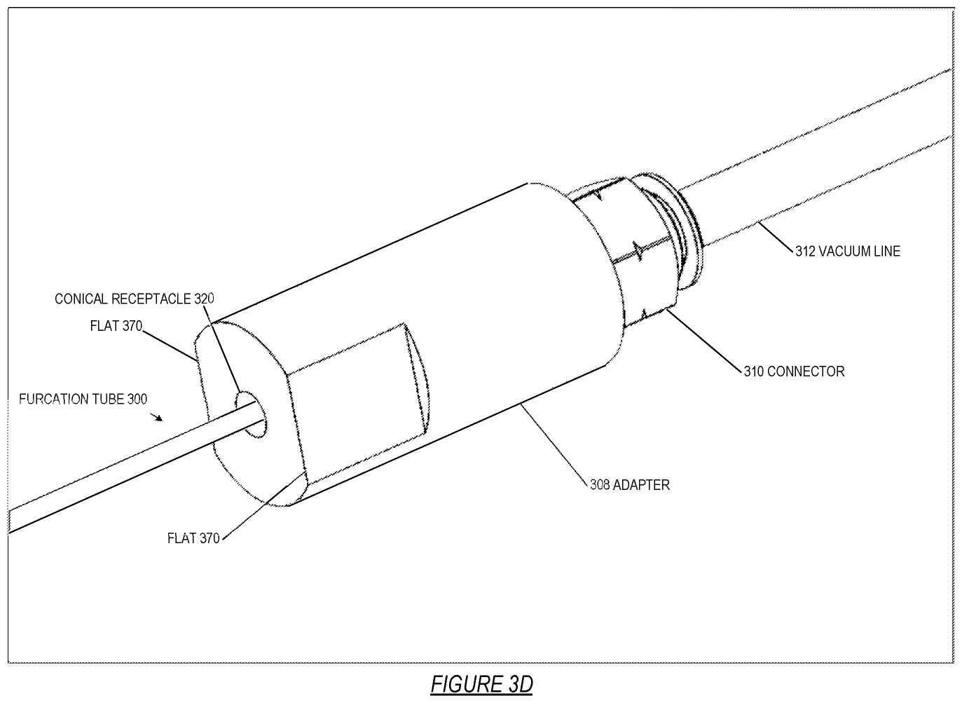

FIG. 3A, FIG. 3B, FIG. 3C, and FIG. 3D depict the assembly of the furcation tube (300) using the adapter (308). The assembly is performed with a vacuum to assist pulling the optical fibers (350) through the furcation tube (300). FIG. 3A, FIG. 3B, FIG. 3C show cross-sectional views of the furcation tube (300), the adapter (308), the connector (310), and the vacuum line (312).

Turning to FIG. 3A, the furcation tube (300) includes the outer sheath (302) and the inner tube (305). The adapter (308) is connected to the connector (310), which is connected to the vacuum line (312). The connector (310) includes the polyhedral cavity (315). In one embodiment, the polyhedral cavity (315) is a hexagonal cavity between the open cavity (318) and the vacuum line (312).

Turning to FIG. 3B, an end of the furcation tube (300) is inserted into the conical receptacle (320) of the adapter (308). The outer sheath (302) of the furcation tube (300) creates a seal to the conical receptacle (320). After insertion of the furcation tube (300) to the conical receptacle (320) of the furcation tube (300), a vacuum is applied.

Turning to FIG. 3C, while a vacuum is applied, the optical fibers (350) are pushed through the furcation tube (300). The optical fibers (350) extend through the adapter (308), through the connector (310), and into the vacuum line (312). After insertion of the optical fibers (350), the vacuum is removed.

Turning to FIG. 3D, a perspective view of the adapter (308) is shown. The furcation tube (300) is inserted into the conical receptacle (320) of the adapter (308). The adapter (308) is substantially cylindrical with a pair of flats (370) structured to be used to twist the adapter (308) with respect to the connector (310).

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

Further, unless expressly stated otherwise, “about” means a reasonable tolerance of plus or minus a specified percentage. A reasonable tolerance may be ten percent. As an example, a length of “about 8 meters” may mean a length in the range of 7.2 to 8.8 meters.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method comprising:
annealing a furcation tube;
inserting the furcation tube into an adapter fitted to a vacuum line;
applying a vacuum to the furcation tube; and
moving one or more communication cables through the furcation tube while the vacuum is applied.

2. The method of claim 1,
wherein a cable of the one or more communication cables comprises an optical fiber.

3. The method of claim 1, further comprising:
applying the vacuum on demand using a vacuum reservoir tank connected to a vacuum pump,
wherein volume of the vacuum reservoir tank maintains a vacuum pressure to provide the vacuum with an airflow for a defined period of time,
wherein the vacuum is less than or equal to about 0.4 pounds per square inch absolute (PSIA), and
wherein the vacuum is applied with the airflow of about 7 cubic feet per minute (CFM).

4. The method of claim 1, further comprising:
inserting the furcation tube into an adapter fitted to a vacuum line,
wherein the vacuum line is a semirigid tube, and
wherein the furcation tube is inserted into conical receptacle of the adapter with an outer diameter of the furcation tube wedged into the conical receptacle to seal the furcation tube to the adapter.

5. The method of claim 1, further comprising:
applying the vacuum,
wherein the vacuum is applied on-demand responsive to a shut-off valve, and
wherein the shut-off valve is a foot operated valve.

6. The method of claim 1, further comprising:
applying the vacuum,
wherein the vacuum applies a force of about 0.2 ounces to an optical fiber of the one or more communication cables.

7. The method of claim 1, further comprising:
moving the one or more communication cables through the furcation tube,
wherein the one or more communication cables comprises an optical fiber with a length of the optical fiber that is drawn into the furcation tube, and
wherein the length of the optical fiber of the one or more communication cables is greater than a length of the furcation tube;
stopping the airflow through the furcation tube from the vacuum with a shut-off valve; and
trimming the length of the optical fiber of the one or more communication cables after drawing the optical fiber into the furcation tube.

8. The method of claim 1, further comprising:
annealing a furcation tube,
wherein annealing comprises:
heating the furcation tube to a hold temperature over a heating period,
holding the hold temperature over a holding period, and
cooling the furcation tube to a room temperature over a cooling period,
wherein the hold temperate is greater than about 500 degrees Celsius,
wherein the heating period is about ten minutes,
wherein the holding period is about twenty minutes,
wherein the cooling period is about twelve minutes, and
wherein the room temperature in the range of about 20 to 25 degrees Celsius.

9. The method of claim 1, further comprising:
moving the one or more communication cables through the furcation tube,
wherein the furcation tube comprises an inner diameter forming a clearance between the inner diameter and diameters of the one or more communication cables,
wherein the clearance is greater than about 0.1 millimeters,
wherein the inner diameter of the furcation tube is about 0.6 millimeters, and
wherein the one or more communication cables comprise two optical fibers each with a diameter of 0.25 millimeters.

10. The method of claim 1, further comprising:
inserting the furcation tube into an adapter,
wherein the adapter comprise a conical receptacle juxtaposed to a cylindrical portion, juxtaposed to an open cavity, and a plurality of threads,
wherein the conical receptacle comprises a proximal end with a proximal diameter greater than an outer diameter of the furcation tube and a comprises a distal end with a distal diameter less than the outer diameter of the furcation tube and greater than the one or more communication cables, and
wherein the open cavity comprises a conical expansion, a cylindrical section, and a substantially cylindrical section.

11. A system comprising:
an adapter; and
the adapter structured to:
receive a furcation tube, wherein the furcation tube is annealed, fit to a vacuum line,
apply a vacuum to the furcation tube from the vacuum line, and
receive one or more communication cables through the furcation tube while the vacuum is applied.

12. The system of claim 11,
wherein a cable of the one or more communication cables comprises an optical fiber.

13. The system of claim 11, wherein the adapter is structured to:
apply the vacuum on demand using a vacuum reservoir tank connected to a vacuum pump,
wherein volume of the tank maintains a vacuum pressure to provide the vacuum with an airflow for a defined period of time,
wherein the vacuum is less than or equal to about 0.4 pounds per square inch absolute (PSIA), and
wherein the vacuum is applied with the airflow of about 7 cubic feet per minute (CFM).

14. The system of claim 11,
wherein the vacuum line is a semirigid tube, and
wherein the furcation tube is inserted into conical receptacle of the adapter with an outer diameter of the furcation tube wedged into the conical receptacle to seal the furcation tube to the adapter.

15. The method of claim 1, further comprising:
wherein the vacuum is applied on-demand responsive to a shut-off valve, and
wherein the shut-off valve is a foot operated valve.

16. The method of claim 1, further comprising:
wherein the vacuum applies a force of about 0.2 ounces to an optical fiber of the one or more communication cables.

17. The system of claim 11,
wherein the one or more communication cables comprises an optical fiber with a length of the optical fiber that is drawn into the furcation tube, and
wherein the length of the optical fiber of the one or more communication cables is greater than a length of the furcation tube.

18. The system of claim 11,
wherein the furcation tube is annealed by:
heating the furcation tube to a hold temperature over a heating period,
holding the hold temperature over a holding period, and
cooling the furcation tube to a room temperature over a cooling period,
wherein the hold temperate is greater than about 500 degrees Celsius,
wherein the heating period is about ten minutes,
wherein the holding period is about twenty minutes,
wherein the cooling period is about twelve minutes, and
wherein the room temperature in the range of about 20 to 25 degrees Celsius.

19. The system of claim 11,
wherein the furcation tube comprises an inner diameter forming a clearance between the inner diameter and diameters of the one or more communication cables,
wherein the clearance is greater than about 0.1 millimeters,
wherein the inner diameter of the furcation tube is about 0.6 millimeters, and
wherein the one or more communication cables comprise two optical fibers each with a diameter of 0.25 millimeters.

20. A system comprising:
an adapter comprising a conical receptacle; and
the adapter structured to:
receive a furcation tube with the conical receptacle, wherein the furcation tube is annealed,
fit to a vacuum line,
apply a vacuum to the furcation tube from the vacuum line, and
receive one or more communication cables through the furcation tube while the vacuum is applied.
